(19) United States
(12) Patent Application Publication
(10) Pub. No.: US 2023/0209631 A1
(43) Pub. Date: Jun. 29, 2023

(54) USING A HUB DEVICE FOR LAND MOBILE RADIO CONFIGURATION

(71) Applicant: BK Technologies Inc., West Melbourne, FL (US)

(72) Inventors: John Marvin Suzuki, Rockville, MD (US); Lorenzo Cruger, JR., Boynton Beach, FL (US); James Lowell Teel, JR., Lynchburg, VA (US)

(73) Assignee: BK Technologies Inc., West Melbourne, FL (US)

(21) Appl. No.: 18/145,323

(22) Filed: Dec. 22, 2022

Related U.S. Application Data
(60) Provisional application No. 63/293,319, filed on Dec. 23, 2021.

(51) Int. Cl. H04W 76/15; H04W 4/08

(52) U.S. Cl. CPC H04W 76/15; H04W 4/08

(57) ABSTRACT

A method for configuring a land mobile radio (LMR) may include providing a hub device and providing a destination LMR device. The hub device may include a hub memory, a hub communication interface, and a hub processor operably coupled to the hub memory and the hub communication interface. The destination LMR device may include a destination LMR memory, a LMR destination communication interface, and a LMR destination processor operably coupled to the destination LMR memory and the destination LMR communication interface. The method may further include storing a configuration parameter in the hub memory, establishing communication between the hub communication interface and the destination LMR communication interface, transmitting the configuration parameter from the hub memory to the destination LMR memory, and controlling the destination LMR device to implement the configuration parameter.

### CROSS-REFERENCE TO RELATED APPLICATIONS

The present application claims priority to U.S. Provisional Application 63/293,319 filed Dec. 23, 2021, the entire contents of which are incorporated herein by reference.

### BACKGROUND

Land mobile radio (LMR) is a narrowband wireless communication scheme that provides one-talker to many-listener voice communications. LMR is of critical importance to the public safety community, such as fire services, police services, EMT services, rescue agencies, the military, and similar groups, where it may be used for critical communications during emergency events.

LMR subscriber radios may exist in hand-portable or vehicular-mobile form factors, and may require configuration or programming of various parameters in order to communicate with other LMR devices. However, conventional configuration methods may be inconvenient in that they require direct connection to a desktop computer or another radio via an interface cable and/or direct programming on the radio. Typically, only one radio can be configured at a time with this method.

However, in an emergency situation, especially one in which multiple agencies are responding, it may be necessary to rapidly configure a large number of radios while deployed on site. Accordingly, it may be desirable to develop new methods and systems for configuring LMR devices in the field.

### BRIEF SUMMARY

An exemplary embodiment of a method for configuring a land mobile radio (LMR) may include providing a hub device and providing a destination LMR device. The hub device may include a hub memory, a hub communication interface, and a hub processor operably coupled to the hub memory and the hub communication interface. The destination LMR device may include a destination LMR memory, a LMR destination communication interface, and a LMR destination processor operably coupled to the destination LMR memory and the destination LMR communication interface. The method may further include storing a configuration parameter in the hub memory, establishing communication between the hub communication interface and the destination LMR communication interface, transmitting the configuration parameter from the hub memory to the destination LMR memory, and controlling the destination LMR device to implement the configuration parameter.

An exemplary embodiment of a hub device for use with a destination land mobile radio (LMR) unit may include a hub memory, a hub communication interface and a hub processor operably coupled to the hub memory and the hub communication interface. The hub device may be configured to receive a configuration parameter and store the configuration parameter in the hub memory. The hub communication interface may be configured to establish communication with the destination LMR unit. The hub device may be configured to transmit the configuration parameter to the destination LMR unit.

An exemplary embodiment of a land mobile radio (LMR) unit may include an LMR memory, an LMR communication interface, and an LMR processor operably coupled to the LMR memory and the LMR communication interface. The LMR communication interface may be configured to establish communication with a hub device. The LMR processor may be configured to, through the LMR communication interface, receive a configuration parameter from the hub device and store the configuration parameter in the LMR memory. The LMR processor may be configured to implement the configuration parameter.

### BRIEF DESCRIPTION OF THE SEVERAL VIEWS OF THE DRAWINGS

A more particular description will be rendered by reference to exemplary embodiments that are illustrated in the accompanying figures. Understanding that these drawings depict exemplary embodiments and do not limit the scope of this disclosure, the exemplary embodiments will be described and explained with additional specificity and detail through the use of the accompanying drawings in which:

FIG. 1 is a schematic diagram of an LMR configuration system according to an exemplary embodiment;

FIG. 2 is a schematic block diagram of a hub device according to an exemplary embodiment;

FIG. 3 is a schematic block diagram of a client device according to an exemplary embodiment;

FIG. 4 is a schematic diagram showing communication between a hub device and a client device according to an exemplary embodiment;

FIG. 5 is a schematic diagram showing communication between a hub device and a client device according to an exemplary embodiment;

FIG. 6 is a schematic diagram showing communication between a hub device and multiple client devices according to an exemplary embodiment;

FIG. 7 is a schematic diagram showing communication between a hub device and multiple client devices according to an exemplary embodiment;

FIG. 8 is a schematic diagram showing communication between a hub device and multiple client devices according to an exemplary embodiment;

FIG. 9 is a schematic diagram showing communication between cloud memory storage, multiple hub devices, and multiple client devices according to an exemplary embodiment; and

FIG. 10 is a flowchart diagram of a method for configuring LMR units according to an exemplary embodiment.

Various features, aspects, and advantages of the exemplary embodiments will become more apparent from the following detailed description, along with the accompanying drawings in which like numerals represent like components throughout the figures and detailed description. The various described features are not necessarily drawn to scale in the drawings but are drawn to aid in understanding the features of the exemplary embodiments.

The headings used herein are for organizational purposes only and are not meant to limit the scope of the disclosure or the claims. To facilitate understanding, reference numerals have been used, where possible, to designate like elements common to the figures.

### DETAILED DESCRIPTION

Reference will now be made in detail to various exemplary embodiments. Each example is provided by way of explanation and is not meant as a limitation and does not constitute a definition of all possible embodiments. It is understood that reference to a particular “exemplary embodiment” of, e.g., a structure, assembly, component, configuration, method, etc. includes exemplary embodiments of, e.g., the associated features, subcomponents, method steps, etc. forming a part of the “exemplary embodiment.”

A land mobile radio (LMR) device may require one or more configuration parameters in order to properly communicate with other LMR devices. These configuration parameters may be stored in one or more files or data structures, and may be referred to as a “codeplug” by those skilled in the art.

In an exemplary embodiment, the codeplug may include information such as radio unique information (including, but not limited to, unit ID, password, serial number), user interface settings (including, but not limited to, backlight duration, switch and button function assignments, display settings to select the information shown for each channel, menu settings to select which items are available), miscellaneous technical parameters, conventional channel definitions (including, but not limited to, name, radio frequency for transmit and receive, squelch code for transmit and receive, other signaling information such as two-tone signaling, dual-tone multi-frequency (DTMF) signaling, Motorola data communications (MDC) signaling), trunked talkgroup definitions (including, but not limited to, name, system ID, system parameters, site ID, control channel frequencies), zone definitions (including, but not limited to, grouping of channels/talkgroups), and scan lists. For the purposes of this disclosure, it will be understood that the phrase “configuration parameter” may refer to one or more pieces of information included in the codeplug.

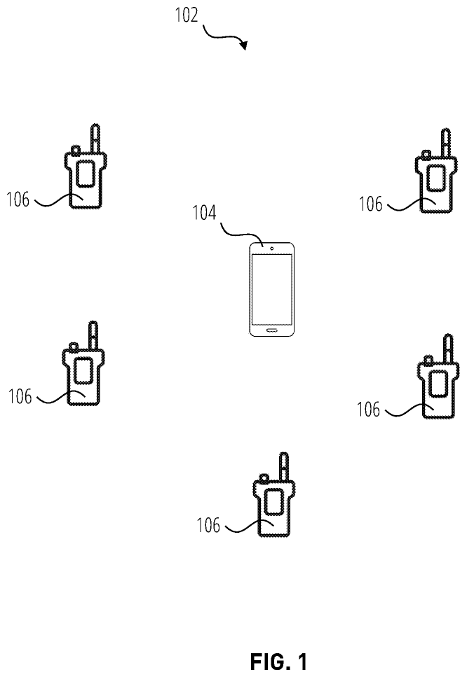

FIG. 1 shows an exemplary embodiment of an LMR system 102. The LMR system 102 may include a hub device 104 and one or more client devices 106. FIG. 1 depicts the hub device 104 as a smartphone, but it will be understood that the disclosure is not limited to this. For example, the hub device 104 may be a tablet computer, a laptop computer, a desktop computer, or the like. In an exemplary embodiment, the hub device 104 may be portable and may be configured to communicate with the Internet via cellular communication, satellite communication, and/or through wireless LAN. In an exemplary embodiment, the one or more client devices 106 may be one or more destination LMR devices. FIG. 1 depicts the client device 106 as handheld LMR units, but it will be understood that the disclosure is not limited to this. For example, the client device 106 may be vehicle-mounted LMR unit or a stationary LMR unit.

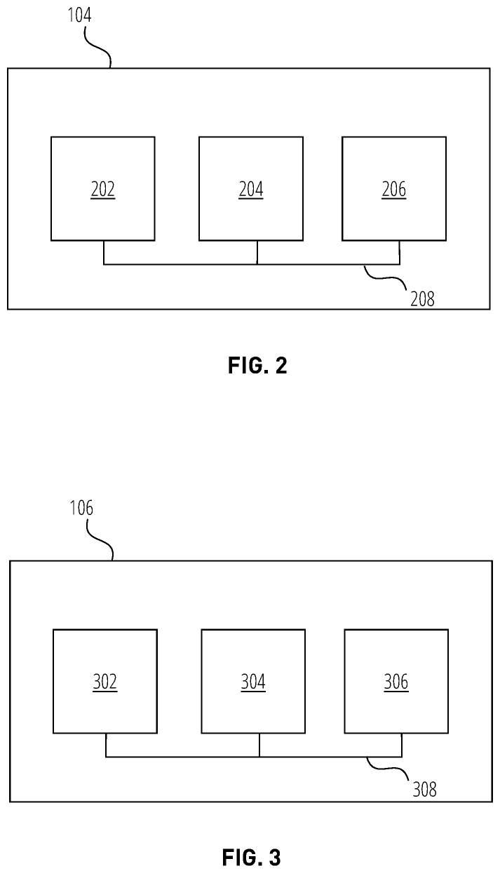

FIG. 2 shows a schematic block diagram of an exemplary embodiment of the hub device 104. The hub device 104 may include a hub processor 202, a hub memory 204, and a hub communication interface 206 mutually operably coupled via a hub bus 208. It will be understood that FIG. 2 is not intended to demonstrate a specific physical arrangement of the hardware of the hub device 104, but is instead intended as a conceptual representation to show what structures may be present in the hub device 104. It will be further understood that the hub device 104 is not limited to the specifically illustrated connections between the parts. For example, in an exemplary embodiment, the hub memory 204 and the hub communication interface 206 may be directly connected only to the hub processor 202, with no direct connection between the hub memory 204 and the hub communication interface 206.

The hub memory 204 may be any non-transitory computer-readable media configured to store data and/or computer-executable instructions. In an exemplary embodiment, the hub memory 204 may be configured to store one or more configuration parameters for an LMR unit, e.g., the codeplug. The hub communication interface 206 may include hardware for wirelessly communicating with other devices including, but not limited to, Bluetooth hardware, near field communication (NFC) hardware, wireless LAN hardware, and/or cellular antenna(s), as well as physical connectors for making wired connections to other devices, including, but not limited to, USB connectors, micro-USB connectors, ethernet connections, Apple Lightning connectors, and/or any other suitable wired connection.

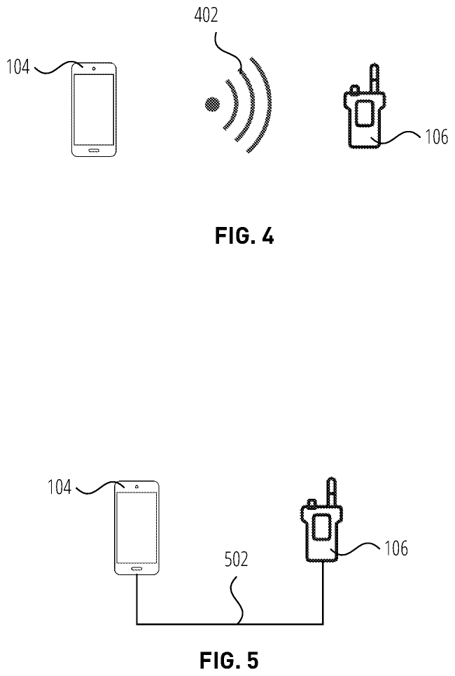

FIG. 3 shows a schematic block diagram of an exemplary embodiment of the client device 106. The client device 106 may include a client processor 302, a client memory 304, and a client communication interface 306 mutually operably coupled via a client bus 308. It will be understood that FIG. 3 is not intended to demonstrate a specific physical arrangement of the hardware of the client device 106, but is instead intended as a conceptual representation to show what structures may be present in the client device 106. It will be further understood that the client device 106 is not limited to the specifically illustrated connections between the parts. For example, in an exemplary embodiment, the client memory 304 and the client communication interface 306 may be directly connected only to the client processor 302, with no direct connection between the client memory 304 and the client communication interface 306.

The client memory 304 may be any non-transitory computer-readable media configured to storing data and/or computer-executable instructions. In an exemplary embodiment, the client memory 304 may be configured to store one or more configuration parameters for an LMR unit, i.e., the codeplug. The hub communication interface 206 may include hardware for wirelessly communicating with other devices including, but not limited to, Bluetooth hardware, near field communication (NFC) hardware, wireless LAN hardware, and/or LMR antenna(s), as well as physical connectors for making wired connections to other devices, including, but not limited to, USB connectors, micro-USB connectors, ethernet connections, Apple Lightning connectors, and/or any other suitable wired connection.

The hub communication interface 206 of the hub device 104 may be configured to establish communication with the client communication interface 306 of the client device 106. In an exemplary embodiment as seen in FIG. 4, the hub device 104 and the client device 106 may communicate via a wireless communication connection 402. The wireless communication connection 402 may be a Bluetooth connection, an NFC connection, a connection over a wireless LAN, or other suitable wireless connection for transmitting data.

In another exemplary embodiment as shown in FIG. 5, the hub communication interface 206 of the hub device 104 may be configured to establish communication with the client communication interface 306 of the client device 106 via a communication cable 502. The communication cable 502 may be connected to the hub device 104 and the client device 106 via one of the connector types described above (e.g., USB, micro USB, ethernet, Apple Lightning) or any other suitable connection type for transmitting data.

Regardless of the particular type of communication between the hub device 104 and the client device 106, in an exemplary embodiment the hub device 104 may be configured to retrieve a configuration parameter from the hub memory 204 and transmit the configuration parameter to the client device 106, where it may be stored within the client memory 304. The client device 106 may be configured to then implement the setting(s) described in the configuration parameter so as to be capable of communicating with other client devices 106 with similar configurations.

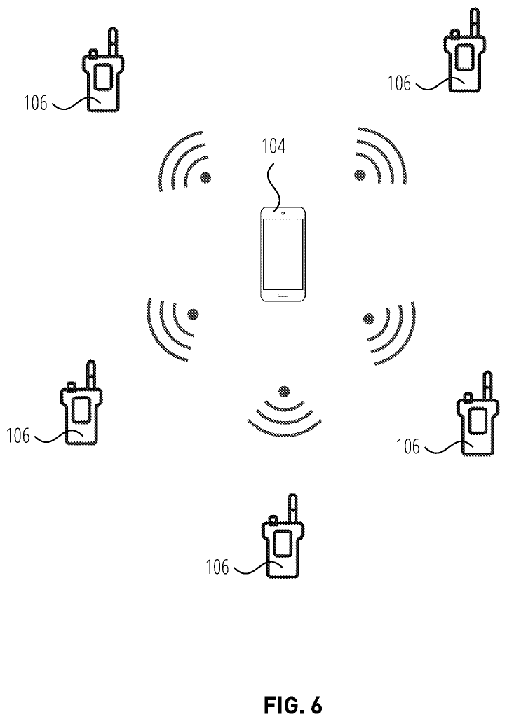

FIG. 6 shows an exemplary embodiment in which the hub device 104 may be configured to communicate with several client devices 106 at once instead of establishing communication with a single client device 106. In other words, the client device 106 may be configured to broadcast the configuration simultaneously to a plurality of client devices 106. For example, the hub device 104 may be configured to use Bluetooth, wireless LAN, NFC, or other suitable wireless communication protocol to broadcast the configuration parameter within the local area (which may be limited by the transmission power of the hub device 104). The plurality of client devices 106 may be configured such that any client device 106 within range of the hub device 104 can receive and implement the configuration parameter being broadcast. To prevent unauthorized devices from having access to the channel or talkgroup being broadcast, various methods such as passwords/passcodes, preprogrammed encryption, authentication tokens, or the like may be implemented.

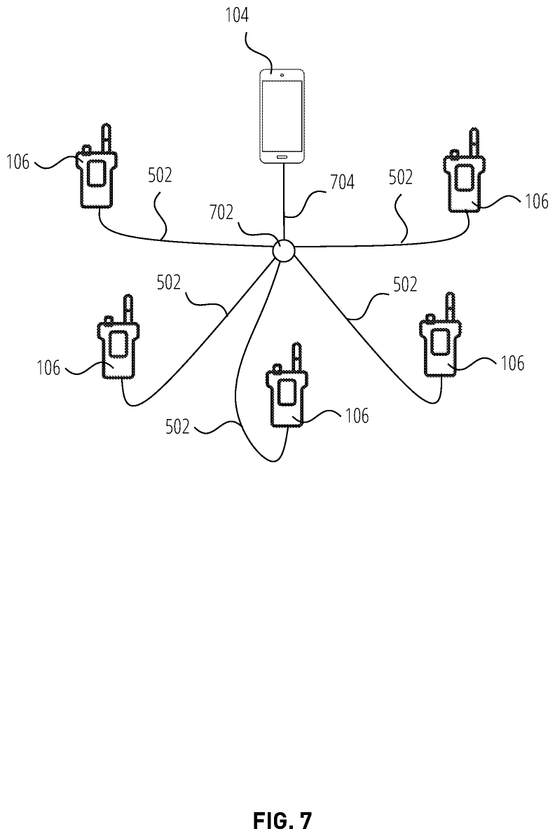

In another exemplary embodiment as seen in FIG. 7, communication cables 502 may be used to facilitate broadcasting the configuration parameter to multiple client devices 106. In an embodiment, a communication cable 502 connected to the hub device 104 may include or be connected to a splitter 702, and then individual communication cables 502 may lead from the splitter 702 to each individual client device 106.

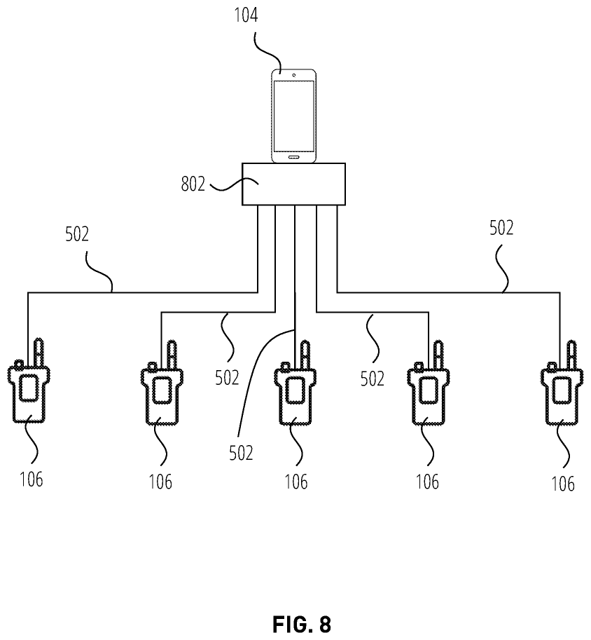

In another exemplary embodiment as seen in FIG. 8, the hub device 104 may be coupled to a docking station 802. Multiple client devices 106 may be connected to the docking station 802 via communication cables 502. Alternatively, the client devices 106 may themselves dock with the docking station 802. Each client device 106 connected to the docking station 802 may then receive the configuration parameter from the hub device 104. In an alternative embodiment, the docking station 802 may itself include a memory in which the configuration parameter may be stored. Thus, a single client device 106 may be used to load the configuration parameter into multiple docking stations 802, thereby significantly multiplying the number of client devices 106 that may be configured at one time.

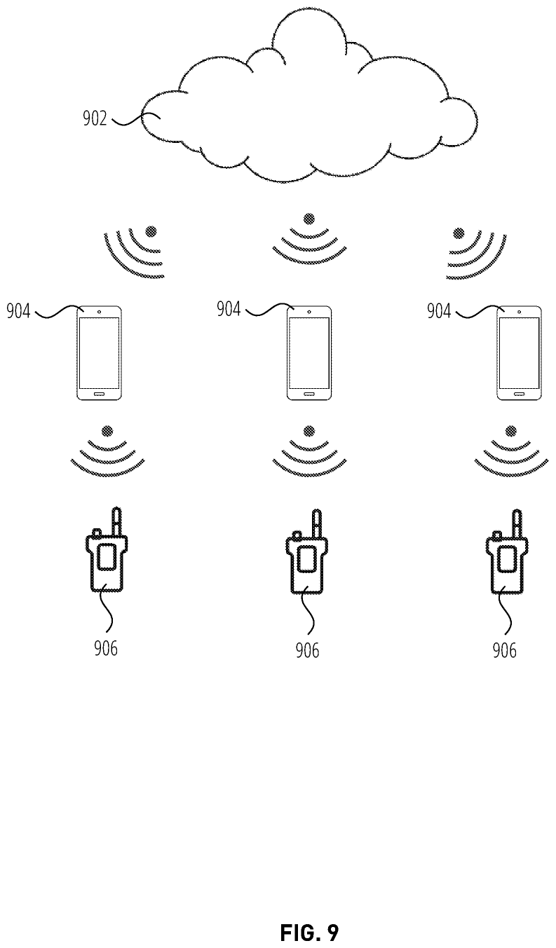

FIG. 9 shows another exemplary embodiment for simultaneously configuring multiple client devices. In current times, smartphones are fairly ubiquitous, and many emergency workers responding to an emergency situation may each have personal smartphones 904. Coordinators may use messaging schemes such as text messaging, email, or the like to send a link for accessing configuration parameter(s) from a cloud memory storage 902 to the emergency workers' smartphones 904. Alternatively, the smartphones 904 may access the configuration parameter(s) from a site coordinator's cell phone or LMR using a wireless or wired connection. The message may also include links for downloading configuration software onto the smartphone 904. Thus, upon arriving at a scene and receiving an LMR unit 906, an emergency worker may access the message and link on the smartphone 904, download the configuration parameter and any required configuration software to the smartphone 904, and then use the smartphone 904 as a hub device to transfer the configuration parameter to the LMR unit 906. This embodiment may be beneficial because it leverages a resource, i.e., the smartphone 904, that is already common among many users. Thus, multiple LMR units 906 may be quickly configured by the users themselves without requiring additional hardware or centralized coordination on site.

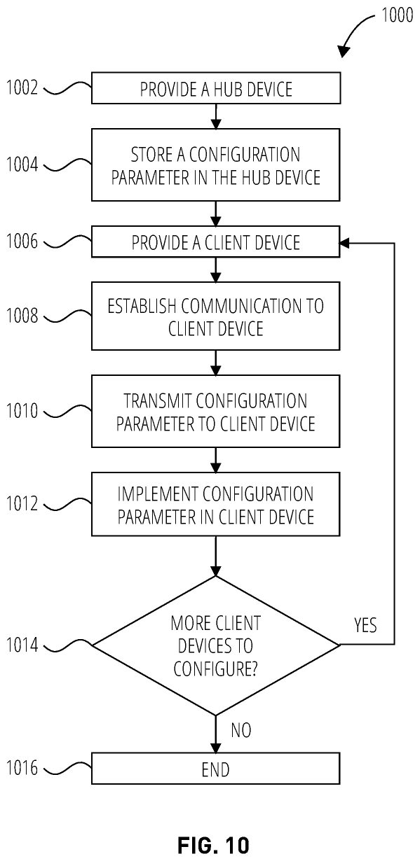

FIG. 10 is a flowchart depicting an exemplary embodiment of a method 1000 for configuring an LMR unit. In block 1002, a hub device 104 is provided. The hub device 104 may be a hub device 104 according to any of the exemplary embodiments described above.

In block 1004, a configuration parameter is stored in the hub device 104. As described above, this may be accomplished by entering the configuration parameter via user input, retrieving the configuration parameter from a cloud memory storage, and/or retrieving a configuration parameter from a pre-configured client device 106, such as a source LMR device. In an exemplary embodiment, the configuration parameter may be stored in a single hub device 104. In an alternative exemplary embodiment, the configuration parameter may be distributed to or received by a plurality of hub devices 104.

In block 1006, a client device 106 is provided. The client device 106 may be a client device 106 according to any of the exemplary embodiments described above.

In block 1008, communication is established between the hub device 104 and the client device 106. As described above, this communication may be wired communication or wireless communication. Additionally, it will be understood that communication may simultaneously be established with several client device 106 at once, as described above with reference to FIG. 6, FIG. 7, and FIG. 8.

In block 1010, the configuration parameter is transmitted from the hub device 104 to the client device 106 and stored within the client device 106. In an exemplary embodiment, the configuration parameter may be distributed to a single client device 106. In another exemplary embodiment, the configuration parameter may be simultaneously broadcast to a plurality of client devices 106.

In block 1012, the configuration parameter is implemented by the client device 106, so that the client device 106 may join the channel or talkgroup defined by the configuration parameter.

In decision block 1014, it is determined whether there are additional client devices 106 to configure. If there are additional client devices 106 to configure (“yes” at decision block 1014), then the method 1000 returns to block 1006, where another client device 106 is provided. If there are no additional devices to configure (“no” at decision block 1014), then the method 1000 proceeds to block 1016 and ends.

In the description above, the hub device 104 is described as transmitting the configuration parameter to the client device 106. However, it will be understood that this is not meant to imply or require that the hub device 104 must initiate the transmission of the configuration parameter. Instead, in an alternative exemplary embodiment, the transmission of the configuration parameter may be initiated from the client device 106 side. In other words, in one exemplary embodiment, a user may transmit the configuration parameter by pressing a button or entering a command on the hub device 104. In an alternative exemplary embodiment, a user may press a button or enter a command on the client device 106 to retrieve the configuration parameter from the hub device 104.

The hub device 104 may be configured in a number of different ways for receiving, retrieving, and/or storing the configuration parameter. In an exemplary embodiment, the hub device 104 may include a user input. The user input may include, but is not limited to, buttons, dials, touchscreens, keyboards, mice, trackpads, and/or any other input device that may be used with a smartphone, tablet computer, laptop computer, or the like. Further, the hub device 104 may include a software application embodied as computer-executable instructions stored in the hub memory 204. The software application may provide a user interface for facilitating entry, storage, and transmission of the configuration parameter. For example, the user interface may be used in conjunction with one or more input devices to input parameters such as transmit/receive frequencies and/or squelch codes, and then store these parameters in the hub memory 204.

In an alternative exemplary embodiment, the hub device 104 may be configured to communicate via the internet with the cloud memory storage 902 In this embodiment, a user may previously set various configuration parameters and save these parameters to the cloud memory storage 902. Then, when needed, the hub device 104 may access the cloud memory storage 902, for example, via cellular connection or wireless LAN connection, in order to access the configuration parameter(s) and store it locally in the hub memory 204. This may provide advantages for users in that the various configuration parameters may be set ahead of time and quickly used for a large number of hub devices 104, rather than having to set configuration parameters on site. As noted above, the hub device 104 may include a software application, which may be configured to provide a user interface for accessing and storing the desired configuration parameter(s) in the hub memory 204. As an alternative to acquiring the configuration parameter from the cloud memory storage 902, the hub device 104 may be connected via cable or wireless LAN to a personal computer or server prior to deployment to the field, and the configuration parameter may be retrieved from such personal computer and/or server and stored on the hub device 104.

In an alternative exemplary embodiment, the hub device 104 may be configured to retrieve the configuration parameter from a client device 106 that is already configured, such as a source LMR device. Alternatively, the source LMR device may be a device belonging to, for example, a site or event coordinator that is tasked with setting up and configuring communications among responders. This source LMR device may be pre-configured with the required configuration parameter(s). In this embodiment, the hub device 104 may establish communication with the pre-configured client device 106 using one of the methods described above. The hub device 104 may then retrieve the configuration parameter from the client memory 304 of the pre-configured client device 106 and store the configuration parameter in the hub memory 204. The configuration parameter can then be transmitted to other client devices 106 as described above.

The description above describes systems and methods for configuring client devices, such as LMR devices, in the field using a hub device to clone and distribute configuration parameter such as a codeplug. In an exemplary embodiment, the codeplug may be initially created on a personal computer or server located at, for example, an agency headquarters. The hub device or hub devices may be configured to distribute this codeplug from the initial creation computer to client devices as described above. In an exemplary embodiment, the hub device may be a smartphone, and the distribution may be carried out via a software application running on the smartphone. In an exemplary embodiment, the software application may be configured for cloning the codeplug to other devices, and may not have the capability of viewing, editing, or creating a codeplug on the smartphone. In another exemplary embodiment, the hub device or smartphone may be capable of creating or editing the codeplug, either as part of the application for cloning the codeplug or as a separate software application provided on the hub device.

This disclosure, in various embodiments, configurations and aspects, includes components, methods, processes, systems, and/or apparatuses as depicted and described herein, including various embodiments, sub-combinations, and subsets thereof. This disclosure contemplates, in various embodiments, configurations and aspects, the actual or optional use or inclusion of, e.g., components or processes as may be well-known or understood in the art and consistent with this disclosure though not depicted and/or described herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

In this specification and the claims that follow, reference will be made to a number of terms that have the following meanings. The terms “a” (or “an”) and “the” refer to one or more of that entity, thereby including plural referents unless the context clearly dictates otherwise. As such, the terms “a” (or “an”), “one or more” and “at least one” can be used interchangeably herein. Furthermore, references to “one embodiment”, “some embodiments”, “an embodiment” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while considering that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that the appended claims should cover variations in the ranges except where this disclosure makes clear the use of a particular range in certain embodiments.

The terms “determine”, “calculate” and “compute,” and variations thereof, as used herein, are used interchangeably and include any type of methodology, process, mathematical operation or technique.

This disclosure is presented for purposes of illustration and description. This disclosure is not limited to the form or forms disclosed herein. In the Detailed Description of this disclosure, for example, various features of some exemplary embodiments are grouped together to representatively describe those and other contemplated embodiments, configurations, and aspects, to the extent that including in this disclosure a description of every potential embodiment, variant, and combination of features is not feasible. Thus, the features of the disclosed embodiments, configurations, and aspects may be combined in alternate embodiments, configurations, and aspects not expressly discussed above. For example, the features recited in the following claims lie in less than all features of a single disclosed embodiment, configuration, or aspect. Thus, the following claims are hereby incorporated into this Detailed Description, with each claim standing on its own as a separate embodiment of this disclosure.

Advances in science and technology may provide variations that are not necessarily express in the terminology of this disclosure although the claims would not necessarily exclude these variations.

What is claimed is:

1. A method for configuring a land mobile radio (LMR), the method comprising:
providing a hub device comprising:
a hub memory;
a hub communication interface; and
a hub processor operably coupled to the hub memory and the hub communication interface;
storing a configuration parameter in the hub memory;
providing a destination LMR device comprising:
a destination LMR memory;
a LMR destination communication interface; and
a LMR destination processor operably coupled to the destination LMR memory and the destination LMR communication interface;
establishing communication between the hub communication interface and the destination LMR communication interface;
transmitting the configuration parameter from the hub memory to the destination LMR memory; and
controlling the destination LMR device to implement the configuration parameter.

2. The method of claim 1, wherein the hub device is a smartphone, a tablet computer, a laptop computer, or a desktop computer.

3. The method of claim 1, wherein:
the hub device further comprises a user input; and
the storing the configuration parameter in the hub memory comprises entering the configuration parameter via the user input.

4. The method of claim 1, wherein the storing the configuration parameter in the hub memory comprises retrieving the configuration parameter from a cloud memory storage.

5. The method of claim 1, further comprising:
providing a source LMR device comprising:
a source LMR memory;
a source LMR communication interface; and
a source LMR processor;
wherein the configuration parameter is initially stored in the source LMR memory; and
the storing the configuration parameter in the hub memory comprises:
establishing communication between the hub communication interface and the source LMR communication interface; and
transmitting the configuration parameter from the source LMR memory to the hub memory.

6. The method of claim 1, wherein the establishing communication between the hub communication interface and the destination LMR communication interface comprises:
establishing a wireless communication connection between the hub communication interface and the destination LMR communication interface,
wherein the wireless communication connection is one of a Bluetooth connection, a wireless LAN connection, or a near field communication (NFC) connection.

7. The method of claim 1, wherein the configuration parameter comprises:
a channel definition or a trunked talkgroup definition.

8. The method of claim 1, wherein:
the destination LMR device is one of a plurality of client devices; and
the hub device is configured to broadcast the configuration parameter to the plurality of client devices.

9. A hub device for use with a destination land mobile radio (LMR) unit, the hub device comprising:
a hub memory;
a hub communication interface; and
a hub processor operably coupled to the hub memory and the hub communication interface;
wherein the hub device is configured to receive a configuration parameter and store the configuration parameter in the hub memory;
the hub communication interface is configured to establish communication with the destination LMR unit; and
the hub device is configured to transmit the configuration parameter to the destination LMR unit.

10. The hub device of claim 9, wherein the hub device is a smartphone, a tablet computer, a laptop computer, or a desktop computer.

11. The hub device claim 9, wherein the hub device further comprises a user input configured to enter the configuration parameter.

12. The hub device of claim 9, wherein:
the hub device is configured to communicate with a cloud memory storage; and
the hub device is configured to retrieve the configuration parameter from the cloud memory storage.

13. The hub device of claim 9, wherein:
the hub device is configured to communicate with a source LMR unit;
the configuration parameter is stored in the source LMR unit; and
the hub device is configured to retrieve the configuration parameter from the source LMR unit and store the configuration parameter in the hub memory.

14. The hub device of claim 9, wherein the hub communication interface is configured to connect to the destination LMR unit via a wireless communication connection, the wireless communication connection including one of a Bluetooth connection, a wireless LAN connection, or a near field communication (NFC) connection.

15. The hub device of claim 9, wherein:
the configuration parameter is one of a plurality of configuration parameters; and
the hub device is configured to transmit the plurality of configuration parameters to the destination LMR unit.

16. The hub device of claim 9, wherein the configuration parameter comprises a channel definition or a trunked talkgroup definition.

17. The hub device of claim 9, wherein:
the destination LMR unit is one of a plurality of destination LMR units; and
the hub device is configured to broadcast the configuration parameter to the plurality of destination LMR units.

18. A land mobile radio (LMR) unit comprising:
an LMR memory;
an LMR communication interface; and
an LMR processor operably coupled to the LMR memory and the LMR communication interface;
wherein the LMR communication interface is configured to establish communication with a hub device;
the LMR processor is configured to, through the LMR communication interface, receive a configuration parameter from the hub device and store the configuration parameter in the LMR memory; and
the LMR processor is configured to implement the configuration parameter.

19. The LMR unit of claim 18, wherein:
the LMR communication interface is configured to connect to the hub device via a wireless communication connection; and
the wireless communication connection is one of a Bluetooth connection, a wireless LAN connection, or a near field communication (NFC) connection.

20. The LMR unit of claim 18, wherein the configuration parameter comprises a channel definition or a trunked talkgroup definition.
